(19) United States
(12) Patent Application Publication
(10) Pub. No.: US 2003/0130868 A1
(43) Pub. Date: Jul. 10, 2003

(54) Real-time prescription transaction with adjudication across a network

(76) Inventor: Rohan Coelho, Portland, OR (US)

Correspondence Address: James H. Salter, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/039,210

(22) Filed: Jan. 4, 2002

(51) Int. Cl. G06F 17/60

(52) U.S. Cl. 705/2

(57) ABSTRACT

The present invention provides for performing a prescription transaction through a portable healthcare device, including adjudication of the prescription. A prescription proposal is created by the portable healthcare device and transmitted to a benefits manager, where the proposal is immediately adjudicated. The adjudication results are prepared by an access server for reading at the portable healthcare device and are considered by the healthcare professional in generating a prescription. The prescription is sent into an end-to-end communication system that includes a real-time communication channel between the portable healthcare device and a remote prescription site. In addition, other aspects of the present invention relating to the adjudication in a prescription transaction.

### FIELD OF THE INVENTION

The present invention relates generally to conducting electronic prescription transactions in real-time. In particular, this invention is related to a communication of a portable healthcare device with a remote healthcare benefits manager, such as a Pharmacy Benefit Manager (PBM), across a network for generating a prescription.

### BACKGROUND

There are growing uses for handheld devices in conducting prescription-related transactions that involve exchanges of electronic information across a network. Health professionals, such as physicians, medical staff, dentists, pharmacists, health plan administrators, public health officials, etc. may use handheld devices in performing their daily workflow.

One particular task is electronic prescription service, referred to as “e-prescribing”, and is usually performed by submitting online claims to remote payers and electronically routing orders to pharmacies, including retail, online or mail order pharmacies. E-prescribing enables a healthcare professional to write, order and renew prescriptions and to review information related to selected prescription items. E-prescribing may reduce callbacks from patients and pharmacists, as well as decrease medical errors caused by illegible handwriting or adverse drug interactions.

With current e-prescribing systems, a remote benefits manager, such as a PBM, communicates with a pharmacy and adjudicates a prescription that has been written by a healthcare professional to determine whether it is in compliance with a pre-established formulary for a patient. In this manner, a benefits manager manages the process of health insurance companies paying for prescriptions. The benefits manager also retains prescription-related information regarding specific patients, such as patient prescription history, formularies for the patient, and other such information applicable to prescription program administration.

Prescription-related information exchanged between the benefits manager and health professional may result in increase formulary compliance, causing the benefits manager to receive higher margins for filling drugs based on formularies. In addition, there may be improved prescription compliance where health professional receives prescription history information, such as whether a patient had filled a new prescription and whether a patient had received a refill within the prescribed time.

It would be advantageous for a healthcare professional to be privy to this recent and patient-specific information at the time of writing a prescription. However, present handheld devices do not communicate in real-time with benefits managers during the writing of a prescription. Therefore, any formulary information retrieved from a benefits manager may not be specific for a patient, include consideration of its past history, encompass patient eligibility, etc. Furthermore, the formulary information must be analyzed by the healthcare professional through the use of software applications. Because each benefits manager may provide formulary information in a different format, the healthcare professional must have specialized software to support each benefits manager, which must be further updated when a benefits manager changes the format of the information.

Where writing prescriptions is best performed as a patient is being cared for, i.e. at the point of care, real-time adjudication of prescriptions by the remote benefits manager while the prescription is being transacted is often not feasible with present communication systems. Several parties must participate and instantaneously respond, by concurrently communicating with and accessing to health information that is kept at a site located across a network at a benefits manger. Present health communication systems do not provide convenient interaction between handheld devices and such benefits managers on a real-time basis.

Furthermore with existing systems, the process of transferring data between an external site and a handheld device is performed in batch off-line, where the data is processed at each segment of the network pathway according to its place in queue. Thus, delays may occur as the data waits its turn to be processed and passed through the pathway. In addition, data generated at a handheld device is usually first transferred to a computer, such as through a docking system, where the data remains until the computer picks up the data and transfers it into the network. Consequently, there presents considerable postponement in providing health services.

In general, the shortcomings of the currently available methods for performing electronic prescription transactions are inadequate to allow real-time transmission between a handheld device and a remote benefits manager. In particular, previous methods do not provide an open pipeline to obtain adjudication results from a benefits manager during the course of generating and transacting a prescription.

### BRIEF DESCRIPTION OF THE DRAWINGS

The present invention is illustrated by way of example, and not limitation, in the figures of the accompanying drawings in which:

FIG. 1 is a block diagram illustrating one embodiment of a health information system having a user system that communicates with one or more benefits manager and remote sites, in accordance with the teachings presented herein.

FIG. 2 is a block diagram example of a portable healthcare device to propose and perform a prescription transaction, in accordance with the teachings presented herein.

FIG. 3 is a block diagram example of an access server to process communications from the portable healthcare device, in accordance with the teachings presented herein.

FIG. 4 is an illustration of exemplary remote benefits manager databases.

FIGS. 5A and 5B are flow charts depicting prescription adjudication methods, wherein FIG. 5A shows transacting a prescription by coordinating with a benefits manager and FIG. 5B shows the role of a portable healthcare device, access server, benefits manager for transacting a prescription, in accordance with the teachings presented herein.

FIG. 6 is a block diagram depicting the transferring of payload data across a real-time network pathway, according to teachings presented herein.

FIG. 7 is a block diagram of a machine-accessible medium storing executable code and/or other data to provide one or a combination of mechanisms to control prescription transactions, in accordance with one embodiment of the present invention.

### DETAILED DESCRIPTION

The present invention provides for adjudication of prescriptions during the course of performing a prescription transaction through a portable healthcare device. A prescription proposal is created by the portable healthcare device and transmitted to a benefits manager, where the proposal is immediately adjudicated. The adjudication results are prepared by an access server for reading at the portable healthcare device and are considered by the healthcare professional in generating a prescription. The prescription is sent into an end-to-end communication system that includes a real-time communication channel between the portable healthcare device and a remote prescription site.

Unlike current batch mode connections to a benefits manager that permit only general formularies to be downloaded, the received adjudication results is recent and specific for a particular patient and proposed prescription, in response to a real-time inquiry by the healthcare professional. Without this recent patient-specific information, it is uncertain whether a prescription complies with the patient's current formulary, eligibility status, includes up-to-date and optimal parameters, etc. Thus, the electronic prescription system of the present invention assists in generating correct and desirable prescriptions.

The user of the portable healthcare device may be any organization comprised of a health professional or individual who is a health professional, such as a healthcare provider, e.g. a provider of medical or prescription-related services. The user decides on the prescription proposal and proposal or imparts the proposal and/or prescription under direction of an individual who is authorized to perform such tasks. There may be one or more than one user of a single portable healthcare device.

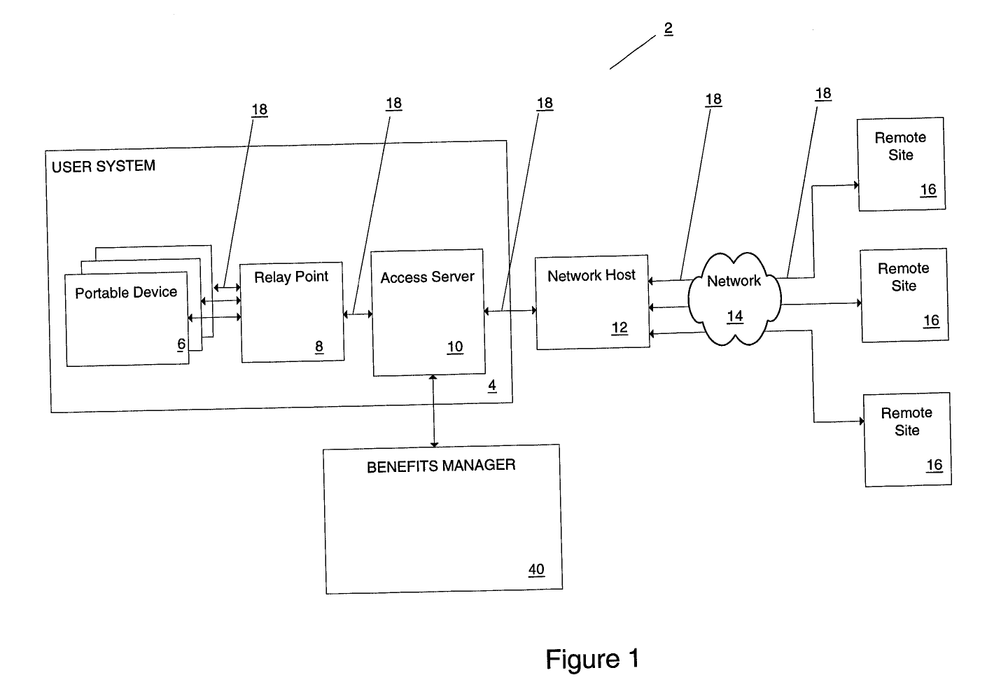

FIG. 1 illustrates an exemplary embodiment of an integrated health information system 2 having various segments along a network pathway 18 and communication with a remote benefits manager 40 to adjudicate a prescription proposal from the portable healthcare device. The network pathway 18 is an open network channel that provides a constant connection of the segments of the pathway so that prescription-related information may continually flow through the segments between any given portable healthcare device and a select remote prescription site. A user system 4 communicates with the remote benefits manager 40. The user system also communicates with one or more remote prescription sites 16 through an external network 14 and along the network pathway 18, according to the present invention. Within the user system 4, at least one portable healthcare device 6 is to communicate with an access server 10 often through one or more relay points 8 along the network pathway 18. Also, a network hub 12 in the network pathway 18 provides a connection from the user system to the external network 14.

Although FIG. 1 demonstrates a particular layout of integrated health information system, the scope of the present invention also anticipates other variations of the system to provide for transfer of information related to a prescription. Any number of portable healthcare devices may be in communication with any number of remote prescription sites through any number of relay points, including no relay points, leading to one or more access servers, which may be arranged in various fashions within the network environment. An integrated health information system may also include any number of network pathways. Furthermore, a user system may communicate with one or multiple benefits manager having patient specific information useful in adjudicating prescriptions. In one embodiment, the access server and/or network hub may further be shared by various other user systems. In still other embodiments, no network hub is employed and the access server directly links to the network.

The user system 4, e.g. a clinic, hospital, office, etc., includes at least a wireless internal network for the portable healthcare device or a group of portable healthcare devices. The user system may incorporate a wireless local area network (LAN) through which the components communicate. The user system may also include a wired internal network that communicates with the wireless internal network.

Through the wireless link within the user system, the portable healthcare device 6 provides for transmission and/or receipt of prescription-related information. A health professional may use the portable healthcare device during the course of performing other daily tasks, such as caring for a patient, and simultaneously send and/or obtain prescription-related information “on the fly”. The portable healthcare device conveniently connects a health professional to sources outside of the user system, e.g. benefits manager and a remote prescription site, in real-time and with minimal interruption to the healthcare professional. The health professional may use the portable healthcare device to send a prescription proposal for a particular patient to a benefits manager via the access server and the user may virtually instantaneously, e.g. within a few seconds, receive the adjudication results from the benefits manager in response.

The portable healthcare device 6 may include a variety of devices that are easily moveable or mobile and that may generate a prescription, submit and/or receive prescription-related information, including the prescription, in electronic form via a network. The portable healthcare device is usually a handheld computer that is of sufficient size to be used while a person is carrying it and often to be conveniently stored in a pocket. However, in some cases the portable healthcare device may also be temporarily converted from a transportable apparatus to a fixed unit, i.e. not easily movable, and which may have a wired connection to another computer system, when desired.

The portable healthcare device is an intelligent wireless device, such as a personal digital assistant (PDA), e.g. the iPAQ® Pocket PC (from Compaq Computer Corporation, located in Houston, Tex.) and Jornada® (from Hewlett-Packard Corporation, located in Palo Alto, Calif.); a wireless telephone (e.g. cellular, personal communications services (PCS), etc.), a wearable computer, a pager, a BlackBerry™ (from Research in Motion, Ltd., located in Ontario, Canada) or other wireless intelligent device that is portable and may additionally have specific components for use in the integrated health information system. The device may be a wireless, portable computer system, such as a laptop, pocket computer, etc., e.g. a personal computer (PC), such as a Macintosh® (from Apple Corporation of Cupertino, Calif.), Windows®-based PC (from Microsoft Corporation of Redmond, Wash.), or one of a wide variety of hardware platforms that runs the Microsoft's Pocket PC (from Microsoft), UNIX®, Sting or Linux® operating systems or other operating systems. The devices listed are by way of example and are not intended to limit the choice of apparatuses that are or may become available in the portable wireless communications device field that may send or receive information without the need for wires or cables to transmit information, as described herein.

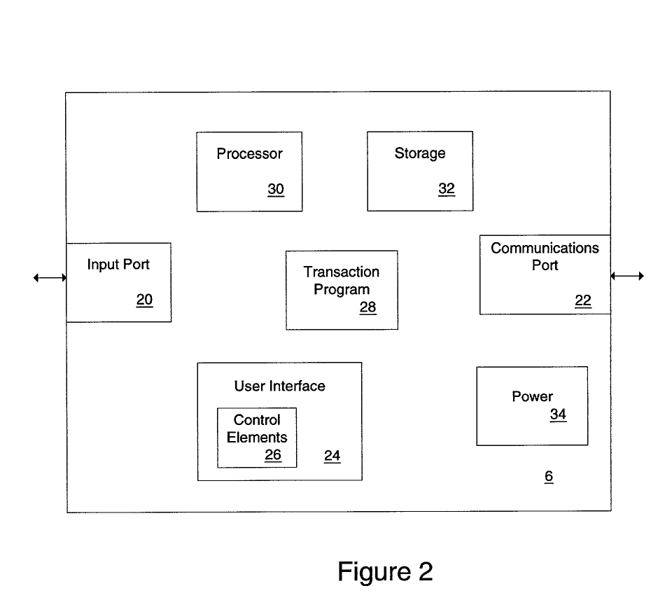

FIG. 2 depicts one embodiment of a portable healthcare device 6 having a communication port 22 to forward data to and receive data from components of the user system, e.g. the access server, relay point(s) and/or other components along the network pathway. For example, the wireless communication port 22 may send a prescription proposal, prescription, or other prescription-related information into the wireless portion of the network pathway, which may be passed directly to an access server or through at least one relay point that in turn transmits the information to the internal network for receipt at the access server.

The wireless communication port 22 communicates with the next receiving point, e.g. relay point or access server, in the network pathway through a wireless communication segment of the pathway. The wireless communication port 22 may communicate through electromagnetic transmissions, such as infrared radiation and radio frequency (RF), usually according to any of the numerous communication standards used in the telecommunication industry. A common standard protocol is the IEEE 802.11b (Institute of Electrical and Electronics Engineering, std. 802.11b, published by IEEE, September 1999), WiFi™, Bluetooth, etc. In addition, various protocols may be used by the portable healthcare device to communicate within the user system, such as a network layer (Open Systems Interconnection (OSI) standards established by the International Standards Organization (ISO).

The portable healthcare device 6 also includes an input unit 20 to enter prescription-related information to the portable healthcare device components to be sent to an access server. In some cases, the prescription-related information entering the system may be in a raw format, such as voice data. This raw format data may require further processing by the portable healthcare device, access server or other component of the user system. In other cases, the data is in a format that is useable by an access server, benefits manager, and/or remote prescription site.

The input port may be coupled to a user interface 24 for presenting to the user, prescription-related information, such as adjudication results, a prescription, etc., that arrives or departs, such as on a display screen. In other embodiments, the input port may directly connect to a prescription-related information source. The presentation of prescription-related information on the user interface may be of assistance to the user in generating a prescription. The user interface 24 may be a visual interface, e.g. display; an audio interface, e.g. microphone, speaker, etc.; and/or a kinesthetic interface e.g. contact sensitive surface, deformable surface, etc. The user interface may include one or more control elements 26 to generate prescription-related information.

There are various types of control elements that may be include in the user interface. One type of control element is visible through a display screen type user interface, e.g. a liquid crystal display, which may be integrated with the portable healthcare device or coupled to the device. Such control elements may include buttons, pop-up or pull-down menus, scroll bars, iconic images, and text entry fields. The visual control elements may be activated by a variety of mechanisms, such as a touch pad screen, pen-to-text data entry device, or activation mechanisms present on input/output devices, such as a keyboard and/or a mouse. Other control elements may be invisible to a display, such as voice or audio recognition elements, optical recognition elements, touch responsive elements, etc. There are a variety of interactive mechanisms to activate invisible and/or visible controls, such as voice or audio commands, touch movement or imprints, network signals, satellite transmissions, preprogrammed triggers within the system, instructional input from other applications, etc.

One or more prescription transaction software program(s) 28 may provide prompts for the user to input through the user interface desired prescription transaction parameters, and the like. The transaction program may also provide prompts for the user to submit patient information related to particular prescription-related information. In one situation, the transaction program may provide a list of options that may be included in a prescription or prescription proposal from which the user may chose. In another case, the transaction program may consider received adjudication results to determine an appropriate prescription. The program may adjust a prescription proposal according to the adjudication results, including any suggested alternatives. For example, where the proposal is declined and at least one alternative is recommended by a benefits manager, the software program may integrate one of the alternatives into the program or present the alternatives to the user for selection.

The software program is suitable to read information that has been prepared by an access server. Usually, the portable healthcare device need not employ specialized software programs, for each format of adjudication communications sent from different benefits managers. In general, the portable healthcare device may deliver numerous prescription-related transactions through various software programs, such as TouchWorks™ (from Allscripts Healthcare Solutions, located in Illinois).

The portable healthcare device 6 also includes processor 30, which may represent one or more processors to run an operating system and applications software that controls the operation of other device components. Some exemplary processors are an Intel Pentium® (or ×86) processor, a Motorola® Power PC processor, etc. The processor 30 may also be a microprocessor. The processor may be configured to perform multitasking of several processes at the same time.

A bus (not shown) may also be provided to carry information between portable healthcare device components. The width of the bus determines how much data can be sent between components, such as 8-bit, 16 bit 32 bit, 64 bit (e.g. Peripheral Component Interconnect (PCI) bus), etc. However, in some variations of portable healthcare device, particular components may couple directly to each other or through a dedicated bus for the particular components, rather than connecting through a general bus.

A storage unit 32 is provided to hold data related to specific prescription-related information, one or more option menu(s) for display to the user through the user interface, prescription-related information and/or other transaction-related data. The storage unit 32 may be any magnetic, optical, magneto-optical, tape, and/or other type of machine-readable medium or device for writing and storing data. For example, the storage unit 32 may be a writeable optical compact disc (e.g. CD ROM, DVD), a disc, tape, random access memory (RAM), such as dynamic RAM (DRAM) and static Ram (SRAM), etc. The amount of storage required depends on the type and amount of data stored.

Often a non-volatile storage, e.g. electrically erasable program read only memory (EEPROM), Flash memory, or cache, is provided for the operating system and resident software applications. The storage unit may also be a hard drive, either integrated within the system, or external and coupled to the system. The storage unit may also be coupled to other types of multiple storage areas that may be considered as part of the storage unit or separate from the storage unit. These storage units 32 described are by way of example and are not intended to limit the choice of storage that are or may become available in the data storage field, as described herein.

A power unit 34 is included with the portable healthcare device to supply energy used to operate the device components. In one embodiment, the power unit 34 may be an energy storage area to hold power, which may be integrated into the device or removable and capable of being inserted into the device. For example, the power unit 34 may be a battery that is charged by energy from an external source. In another embodiment, the power unit 34 may be simply a power connector to direct energy from an external power source to the various device components rather than to store energy.

Furthermore, the portable healthcare device may also have various optional components, such as a biometric data reader or other security measures to ensure permitted access to the internal network, protect transferred data, and the like. Security may be provided through encryption and/or authorization tools.

The transfer of prescription-related information from across the network pathway and the presentation of information is in real-time from the time the information leaves one end of the pathway, e.g. the portable healthcare device, and reaches its destination end, e.g. benefits manager or remote prescription site.

The transmission exiting from the portable healthcare device may pass through one or more relay points(s) 8, e.g. LAN access point(s), that serve as a bridge between the access server and/or an existing wired network and the wireless device. The relay point may also act as a repeater to pass along transmissions from one relay point to another. The relay point may be placed within the performance distance for transmission to form an interconnected transmission pathway. One such relay point is Intel PRO/Wireless 2011 LAN Access Point (by Intel Corporation, located in Santa Clara, Calif.).

Furthermore, in one embodiment of integrated health information system, a controller having intelligence may be provided within the user system to control the relay points. For example, the controller may manipulate the speed, direction, and/or amount of traffic through the relay points.

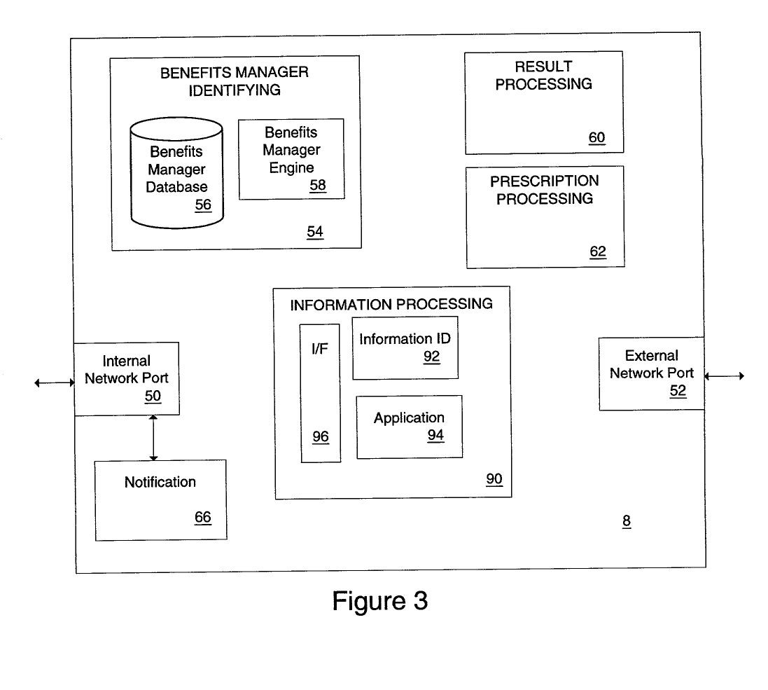

One embodiment of access server 10 in the user system is shown in FIG. 3. An internal network port 50 receives communication, e.g. prescription-related information promulgated from the portable healthcare device, of the internal network of the user system. Furthermore, the access server has an external network port 52 to transport and accept communications with benefits managers and remote prescription sites, such as through a network host.

A benefits manager identifying unit 54 is provided in the access server to determine an appropriate benefits manager, if any exists, is appropriate to receive and adjudicate a particular prescription proposal. For instance, the user may request that a particular benefits manager receive a submitted proposal and the identifying unit confirms that indeed the benefits manager is right for the proposal receipt. Rather than rely on the user's selection, the identifying unit may also search a benefits manager database 56 to find a benefits manager that may receive a proposal and then sends the proposal to the determined benefits manager.

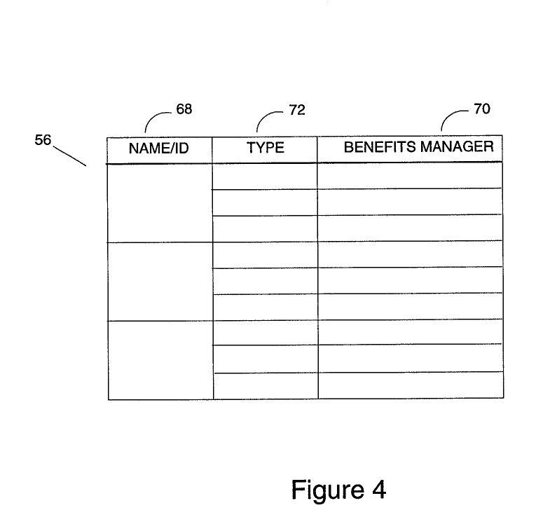

The benefits manager database 56 may store reference to one or more benefits manager for any given user. One example of a benefits manager database 56 is depicted in FIG. 4 having a user field 68 for the user's name and/or identifier. A BM field 70 is for specifying the name and/or identifier for a benefits manager that is appropriate for the corresponding user. In some embodiments, the database is further subdivided into prescription type field 72, where different benefits managers may supervise distinct types of prescriptions. Types of prescriptions may include medical, vision, dental, alternative healthcare, or other categories healthcare that use prescriptions.

A benefits manager engine 58 retrieves from the benefits manager database the reference data that corresponds to a user that has submitted a prescription proposal and optionally also to a prescription type. Based on the reference data, the benefits manager engine determines the appropriate benefits manager to receive the proposal. Appropriateness of a benefits manager may be based, inter alia, on whether a patient has benefits manager coverage, whether the covering benefits manager is enabled to communicate via an electronic connection with the user system, etc.

The access server also includes a results processing unit 60 to prepare adjudication results receive from a benefits manager. In one embodiment, the results are formatted for reading at the benefits manager. Thus, the portable healthcare device need not carry application programs for each format of information used by various benefits managers. In another embodiment, the access server may retain a copy of the proposal prior to sending it to the benefits manager. The results processing unit locates the stored proposal that corresponds to a received result and reformats the proposal to present the results from the benefits manager.

A prescription processing unit 62 may be included to process the prescription received from the portable healthcare device. The prescription processing unit may apply at least one predefined rule to process the prescription, such as rules concerning login, billing-related rules, other business rules, etc.

A notification unit 66 may be optionally provided to inform the user of the status of its proposal and/or transaction. For example, where a requested benefits manager is unable to adjudicate a prescription, the user may be informed that the proposal cannot be adjudicated. Furthermore, the notification unit may send a signal to indicate that the transaction is being processed. In addition, the notification unit 66 may transmit a notice that additional information is required for a transaction to be completed.

In addition, an information processing unit 90 may be provided for processing prescription-related information that is to be sent through the network pathway and/or received from the network. An information identification unit 92 may be included to determine what type of information is received. Furthermore, a server interface 96 is for preparing the prescription-related information to be in a suitable format for the next segment of the network pathway to receive the information.

The identification unit 92 may determine to where the information should be transferred. Such a determination may be made referencing an original request for the prescription-related information or as specified in the transmission unit. The receiving destination may be a requesting portable healthcare device, some other portable healthcare device, a designated electronic device or computer, a network host, a relay point, a remote prescription site, a next segment toward a particular second end of the network, etc. In one embodiment, the information identification unit 92 may recognize the received information as a response to an earlier requested transaction or as a new transaction. For instance, the access server may maintain a log of references to requested transactions and the identification unit compares the incoming information with the references in the log.

Furthermore, the access server 10 may include an application unit 94 to determine the software application program to which the information belongs to and how the information should be entered into the appropriate application. The information may be associated with an application that is specific for the remote prescription site that sent it or multiple remote sites may be supported by one application program.

The access server usually also includes some conventional server components as known in the field. For example, a processor for controlling the other server components, and a storage unit for storing programs, data, bus(es), etc. may be provided.

In still other embodiments of an access server, various other optional components may be present in the access server, which assist in transfer of prescription-related information. The access server may have a back-end processing unit for providing back-end services or support for a front-end application running on a portable healthcare device or other component of the user system. Such back-end processing unit may process raw prescription-related information generated by the portable healthcare device. For example, a speech recognition engine may be included to convert speech data collected by the portable healthcare device.

In addition, the access server may include various components to vary and control the speed of network traffic, protocols based on the amount of noise in the network, encryption protocols, etc.

Benefits manager 40 communicates with the access server 10, usually through the access server's external network port 52. The benefits manager 40 is remotely located from the user system 4 and the connection between the benefits manager 40 and user system is usually an open-line network that is always in contact with the user system. The benefits manager is able to adjudicate a prescription proposal “on the fly” and provide results to the access server immediately upon receiving a request for the check. A network connection between the user system and benefits manager may be a public network, e.g. the Internet, semi-public network that provides for tunneling of data packets, e.g. a virtual private network (VPN), or private network, e.g. dedicated leased communication line, which may only be used by one user system and remote prescription site. Usually, the network provides for security in transport, as in a VPN where special encryption is used at the sending end and decryption at the receiving end.

Often, the benefits manager is a private firm that contracts with health plans or plan sponsors and specialize in claims processing and administrative functions involved with operating a prescription drug program.

The benefits manager tracks prescription criteria for a patient. Examples of the patient prescription criteria that a benefits manager may store includes patient eligibility into a particular health plan according to an insurance company, formulary for the patient, prescription history and patient's fill record for those prescriptions, etc. The benefits manager may also have other prescription criteria that are not specific for a patient, such as comparable items that may be prescribed and their costs, e.g. generic drug versions. One or more of these criteria may be considered for a benefits manager during adjudication to assess a prescription proposal.

In one embodiment, the results of the adjudication may include an acceptance response that the proposed prescription has cleared and the user may continue to transact the prescription as proposed, or a negative answer that the proposal is declined as presently written and must be rewritten in order to carry out the transaction. At times, the results include suggested alternatives. In this case, alternatives may be coupled to a declined proposal and the alternatives may be substituted to generate an acceptable prescription. In the alternative, the alternatives may be included in an accepted proposal result and the alternatives are mere suggestions on forming an even more desirable prescription. In still another embodiment, the adjudication results include the raw patient data stored at the benefits manager. In this embodiment employing raw data results, the access server may consider the data and determine whether a prescription is acceptable to be transacted or withhold permission based on the adjudication results provided from the benefits manager.

The user system is also coupled to a network host 12 in order for the user system to maintain a connection with a network to the remote prescription site. The network host is the hub for all communications traveling to and/or from a user system and external network 14.

The external network 14 is a public network, e.g. the Internet, semi-public network that provides for tunneling of data packets, e.g. VPN, or private network, e.g. dedicated leased communication line, which may only be used by one user system and remote prescription site. Usually, the network provides for security in transport, as in a VPN where special encryption is used at the sending end and decryption at the receiving end. The external network is a constant on-line channel between the remote prescription site and network hub, such that the user system or remote prescription site may communicate with each other at any time.

One or more remote prescription site 16 may receive a prescription or other prescription-related information, from across the respective network pathway and optionally communicate prescription-related information in electronic form with various components of the user system. The remote prescription site fills the prescription transaction, usually immediately upon receiving the prescription. The remote prescription site may also provide a confirmation response into the network pathway to the portable healthcare device after filling the prescription request or a status response of the condition of the transaction fulfillment. Such types of notification may be sent back to the portable healthcare device in real-time relative to the time of submission of the prescription to the remote prescription site.

Oftentimes, the remote prescription site is a pharmacy, including retail, online or mail order pharmacy that supplies a patient with the prescribed item, that may be picked up by or delivered to the patient. Usually, there is a variety of remote prescription sites connected to the network pathway, which may be of different types.

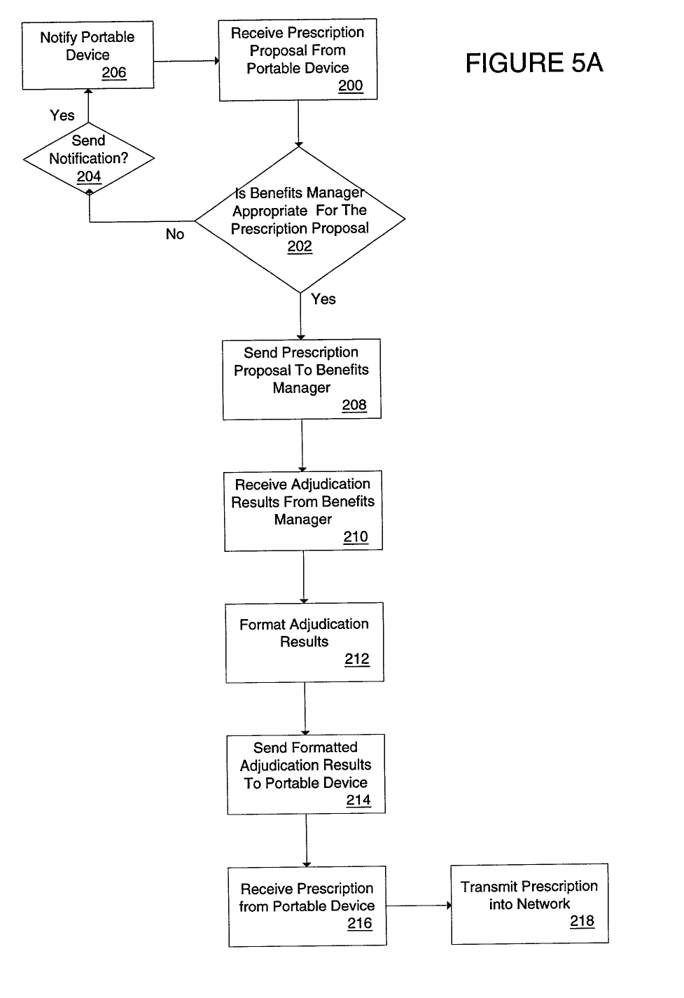

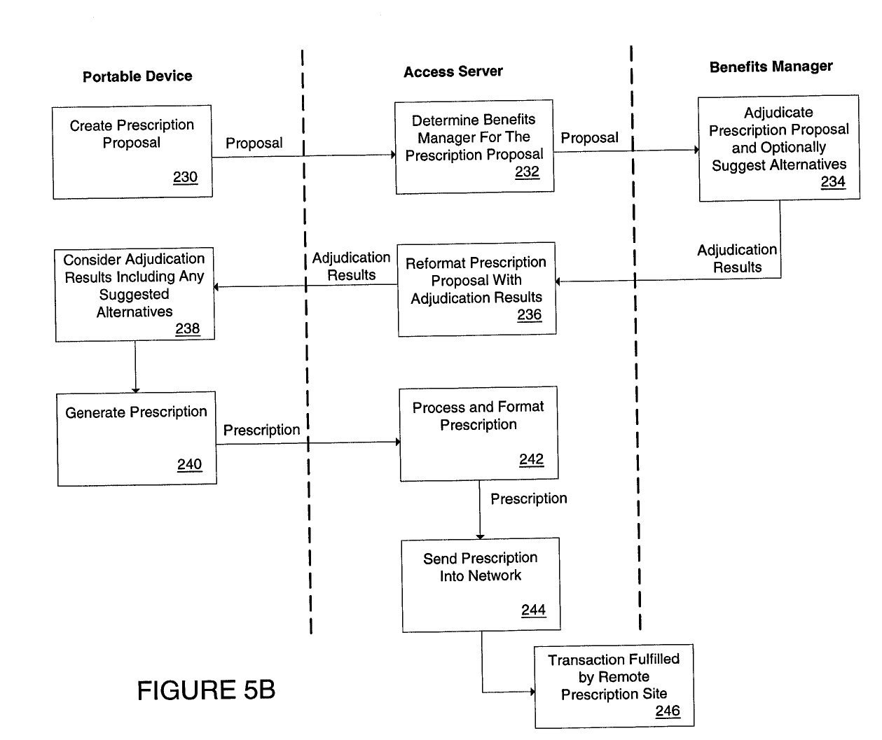

FIG. 5A shows one embodiment of a process to adjudicate a prescription proposal for a prescription transaction, according to the present invention. A prescription proposal is received from a portable healthcare device of the pathway 200. In this illustration, a select benefits manager is identified by the proposing portable healthcare device and may be coupled to the proposal. It is determined whether the selected benefits manager is appropriate for the proposal 202. If the benefits manager is not appropriate, at times the process may opt 204 to send a notification of the failure to the user 206 and the user may resubmit the selected benefits manager 202. At other times no notification is sent of the failure to find an appropriate benefits manager, such as after a predefined number of attempts of the user to submit a selected benefits manager, e.g. three times. Optionally, another appropriate benefits manager may be determined. In any case, the process does not continue to request adjudication of the proposal unless an appropriate benefits manager is determined. The prescription proposal is sent to the appropriate benefits manager through a network channel 208.

Once the adjudication is completed, the results are received 210 and prepared 212. The preparation may include formatting the results so that it may be readable by a portable healthcare device without special translation software applicable to a benefits manager. Preparation may also entail integrating the results to the matching prescription proposal.

The formatted results and proposal is returned back to the portable healthcare device 214. At times, where a proposal is declined by a benefits manager, a new proposal may e sent by a portable healthcare device and the process repeats from the receiving of the proposal 200. Usually the recipient portable healthcare device is the originally proposing device, however, at times the results may be sent to another healthcare portable device or other component of the user system. In response to the adjudication result, a prescription is usually generated. The prescription is received from a portable healthcare device, which is usually the portable healthcare device that obtained the adjudication results 216. The prescription is sent into the network for receipt at a remote prescription site to complete the transaction, e.g. fill the prescription order 218. In some embodiments, the access server may compare the prescription with the adjudication results to check if the prescription is in compliance with the results, and only sends the prescription into the network if the prescription meets the requirements of the results. Where the prescription fails to meet the results, the user may be notified. If there are more prescription proposals for transacting, the process may repeat for each proposal.

The prescription transaction occurs through interactions of a portable healthcare device, access server, benefits manager and remote prescription site of the integrated health system, as shown by one embodiment in FIG. 5B. The portable healthcare device creates a prescription proposal 230 and transfers the proposal to the access server via an internal network. The access server processes the proposal by determining an appropriate benefits manager, if any 232. Where an appropriate benefits manager is identified, the access server transfers the proposal to that benefits manager. The benefits manager adjudicates the proposal by checking stored criteria, e.g. information for the patient of the prescription, related tot eh prescription parameters, etc., and determines whether the prescription meets predetermined prerequisites 234. The benefits manager may also add suggested alternative to the prescription parameters. For example, the suggested alternatives may recommend other drugs, medical devices, and the like; other concentrations or amounts; other directions for use; etc.

The adjudication results are transferred to the access server, which reformats the prescription proposal with the results 236. The access server forwards the reformatted proposal back to the portable healthcare device, where the results are considered, including any suggested alternatives 238. The user generates the prescription 240 and sends it to the access server. The access server may process and format the prescription 242 prior to sending it further into the network pathway towards the remote prescription site 244. Immediately upon receiving the prescription, the remote prescription site satisfies the transaction, such as by filling the prescription 246.

From the time a portable healthcare device requests a transaction, adjudication is rapidly performed if an appropriate benefits manager is located. In addition, as soon as the portable healthcare device submits a prescription, the information swiftly flows through all segments of the network pathway. All steps of the process are instantly performed to achieve seemingly instantaneous, e.g. within a few seconds of time, performance of the prescription transaction, i.e. in real-time.

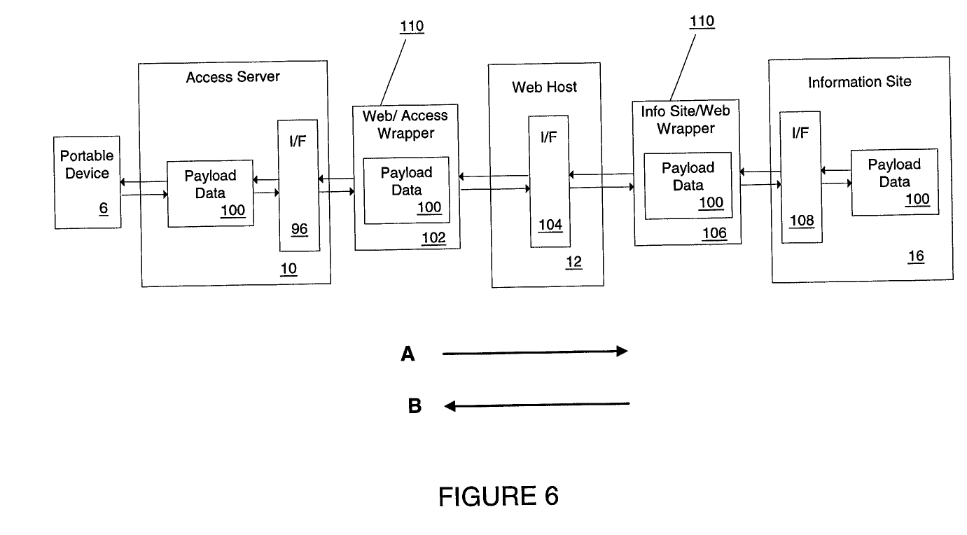

FIG. 6 depicts a network pathway with a global infrastructure to enable applications on the portable healthcare device to provide real-time data or for a remote prescription site to push real-time content to a portable healthcare device, during a transaction. The network pathway has various segments with interfaces for communicating the prescription-related information to a next sequential segment in the pathway. Segments may include an access server, network host, remote prescription site, or other intermediary apparatus along the network pathway that intercepts and/or sends the information.

In conducting a transaction, prescription-related information is directed through the integrated health system as a payload data 100 in a transmission unit 110, e.g. packet, that starts at either end of the pathway, i.e. the portable healthcare device 6 or remote prescription site 16. A body of prescription-related information that is to be transferred through the system is packed into a single transmission unit, or more usually, a stream of multiple transmission units. The interfaces prepare the transmission unit for the next segment and, in most cases, do not alter the prescription-related information as released from the first end of the pathway. Some embodiments of a network pathway provides for bi-directional transfer of prescription-related information between the two ends of the pathway. Where the transmission of the prescription-related information is initiated from the portable healthcare device, i.e. first end, to the remote prescription site, i.e. second end, the transmission units travel in a direction A, and where the communication of the prescription-related information occurs initially from the remote prescription site, i.e. first end, towards the portable healthcare device, i.e. second end, the transmission units move in a direction B.

In the cases that the prescription-related information is sent in direction A, the prescription-related information flows through a server interface 96 of an access server 10. The server interface 96 places the payload data 100 in a wrapper 102 that contains the data recognizable by the next segment, such as the network host 12, in the network pathway. The network host 12 has a host interface 104 that prepares the payload data for reading by a remote prescription site and sends the information into the network 14. Usually, the host interface envelopes the payload data with a remote prescription site wrapper 106 having data, e.g. header information, acceptable by the remote prescription site. The host interface may remove any present wrappers 102 and provide a new wrapper 106 specific for the remote prescription site to receive the information. Oftentimes, each remote prescription site requires different proprietary wrapper information. Upon receipt of the transmission unit by the remote prescription site, the remote prescription site interface 108 removes the wrapper 106 to reveal the payload data 100.

Where the prescription-related information is moved through the network pathway in the direction B, the remote prescription site interface 106 prepares payload data 100 for sending into the network by placing the payload data into a wrapper 106 for web host access. The network host 12 intercepts the transmission unit and passes the unit through a host interface 104 that prepares the payload data for reading by the access server. The payload is placed in a wrapper 102 specific for the access server. The server interface 96 of the access server 10 strips away the wrapper 102 to reveal the payload data. The portable healthcare device receives the prescription-related information and usually immediately presents it to a user.

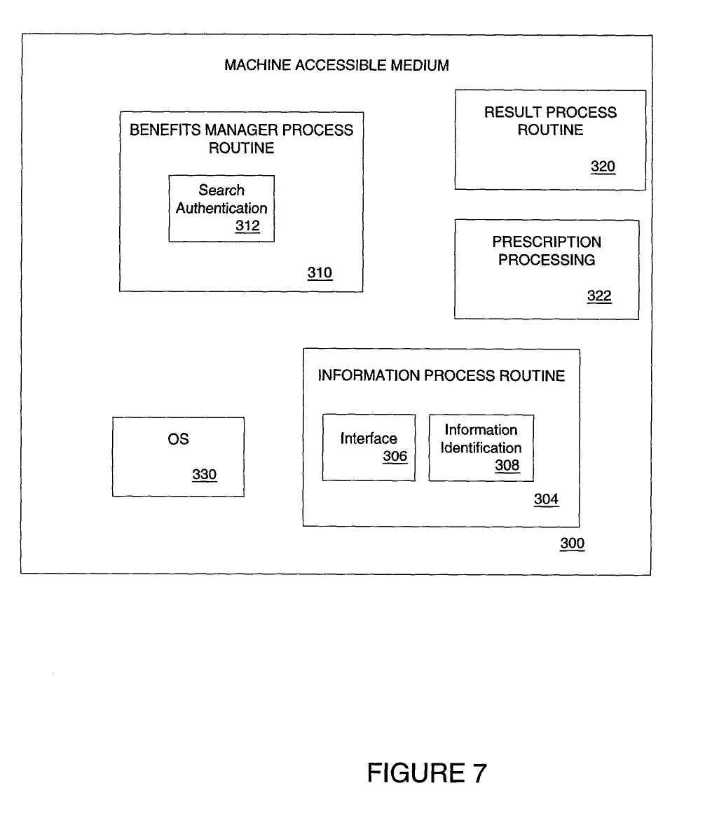

Various software components, e.g. applications programs, may be provided within or in communication with the access server that cause the processor or other components of the server to execute the numerous methods employed in conveying information through a network pathway. FIG. 7 is a block diagram of a machine-accessible medium storing executable code and/or other data to provide one or a combination of mechanisms for transacting a prescription with adjudication, according to one embodiment of the invention.

The machine-accessible storage medium 300 represents one or a combination of various types of media/devices for storing machine-readable data, which may include machine-executable code or routines. As such, the machine-accessible storage medium 300 could include, but is not limited to one or a combination of a magnetic storage space, magneto-optical storage, tape, optical storage, battery backed dynamic random access memory, battery backed static RAM, flash memory, etc. Various subroutines may also be provided. These subroutines may be parts of main routines in the form of static libraries, dynamic libraries, system device drivers or system services. The processes of various subroutines, which when executed, are described above with regard to FIG. 5A.

The machine-readable storage medium 300 is shown having a receive information routine 302, which, when executed, obtains a prescription proposal, prescription and/or other prescription-related information from across a network.

A benefits manager processing routine 310 is for identifying an appropriate benefits manager. This routine involves a search database subroutine 312 for searching and pulling reference to a benefits manager that is suitable to adjudicate a particular prescription proposal from a database.

The result processing routine 320 is for processing adjudication results, where such a result is received from a benefits manager. In addition, a prescription routine 322 may be employed to conduct any necessary processing of a prescription prior to sending into the network pathway.

During a transaction, incoming prescription-related information may be immediately passed to an information processing routing 304. The information processing routine 304 is for processing the receive information through various subroutines. An interface subroutine 306 is for preparing the prescription-related information with appropriate data for reading at the next segment. An information identification subroutine 308 may be executed for identifying the information and/or determining the appropriate next segment to receive the information. A send information routine 310 includes instructions for sending the processed information, in the form of transmission unit(s) into the network towards its ultimate destination.

In addition, other software components may be included, such as an operating system 330.

The software components may be provided in as a series of computer readable instructions that may be embodied as data signals in a carrier wave. When the instructions are executed, they cause a processor to perform the steps as described. For example, the instructions may cause a processor accept information, process the information, forward the information, etc. Such instructions may be presented to the processor by various mechanisms, such as a plug-in, static library, dynamic library, system device driver, system service, etc.

The present invention has been described above in varied detail by reference to particular embodiments and figures. However, these specifics should not be construed as limitations on the scope of the invention, but merely as illustrations of some of the presently preferred embodiments. It is to be further understood that other modifications or substitutions may be made to the described integrated health information system as well as methods of its use without departing from the broad scope of the invention. The above-described steps of transacting prescriptions with adjudication through a real-time healthcare network pathway may be performed in various orders. Therefore, the following claims and their legal equivalents should determine the scope of the invention.

What is claimed is:

1. A method of transacting a prescription, the method comprising:
receiving a prescription proposal from a portable healthcare device for real-time adjudication;
transmitting the prescription proposal to a benefits manager for immediate adjudication of the prescription proposal;
preparing results of the adjudication from the benefits manager for reading at the portable healthcare device; and
forwarding the prepared results to the portable healthcare device to be considered in generating a prescription for transfer in real-time across a network pathway to a remote prescription site.

2. The method of claim 1, further including receiving the prescription from the portable healthcare device and transferring the prescription across the network pathway to the remote prescription site.

3. The method of claim 2, further including processing the prescription according to at least one rule prior to the transferring of the prescription.

4. The method of claim 1, further including determining an appropriate benefits manager to adjudicate the prescription proposal and the transmitting of the prescription proposal occurs if an appropriate benefits manager is identified.

5. The method of claim 1, wherein the adjudication results includes an acceptance or decline of the prescription proposal.

6. The method of claim 1, wherein the adjudication results includes at least one suggested alternative parameter.

7. The method of claim 6, wherein the suggested alternative parameter addresses an adverse drug interaction, compliance with a formulary or patient cost.

8. The method of claim 6, wherein the prescription includes at least one of the suggested alternative parameter.

9. The method of claim 1, wherein the adjudication includes consideration of patient eligibility, drug interaction, formulary compliance or patient healthcare history.

10. A system to transact a prescription, comprising:
a) an internal network port to receive a prescription proposal and a prescription from the portable healthcare device;
b) a benefits manager engine to determine an appropriate benefits manager for a prescription proposal from a portable healthcare device;
c) a result processing unit to prepare adjudication results for reading at the portable healthcare device;
d) an interface to prepare the prescription for receipt by a next segment in the network pathway towards a remote prescription site; and
e) an external network port to transfer the prescription into the network pathway in real-time to the remote prescription site.

11. The system of claim 10, wherein the result processing unit is further to integrate the adjudication results with the prescription proposal.

12. The system of claim 10, further including a prescription processing unit to process the prescription according to at least one rule prior to transferring of the prescription.

13. The system of claim 10, wherein the adjudication results includes an acceptance or decline of the prescription proposal.

14. The system of claim 10, wherein the adjudication results includes at least one suggested alternative parameter.

15. The system of claim 14, wherein the suggested alternative parameter addresses an adverse drug interaction, compliance with a formulary or patient cost.

16. The system of claim 14, wherein the prescription includes at least one of the suggested alternative parameter.

17. A computer accessible medium having stored therein a plurality of sequences of executable instructions, which, when executed by a processor, cause the system to:
receive a prescription proposal from a portable healthcare device for real-time adjudication;
transmit the prescription proposal to a benefits manager for immediate adjudication of the prescription proposal;
prepare results of the adjudication from the benefits manager for reading at the portable healthcare device; and
forward the prepared results to the portable healthcare device to be considered in generating a prescription for transfer in real-time across a network pathway to a remote prescription site.

18. The computer accessible medium of claim 17, further including additional sequences of executable instructions, which, when executed by the processor further cause the system to receive the prescription from the portable healthcare device and transferring the prescription across the network pathway to the remote prescription site.

19. The computer accessible medium of claim 17, further including additional sequences of executable instructions, which, when executed by the processor further cause the system to process the prescription according to at least one rule prior to the transferring of the prescription.

20. The computer accessible medium of claim 17, further including additional sequences of executable instructions, which, when executed by the processor further cause the system to determining an appropriate benefits manager to adjudicate the prescription proposal and the transmitting of the prescription proposal occurs if an appropriate benefits manager is identified.

21. The computer accessible medium of claim 17, wherein the adjudication results includes an acceptance or decline of the prescription proposal.

22. The computer accessible medium of claim 17, wherein the adjudication results includes at least one suggested alternative parameter.

23. The computer accessible medium of claim 22, wherein the suggested alternative parameter addresses an adverse drug interaction, compliance with a formulary or patient cost.

24. The computer accessible medium of claim 22, wherein the prescription includes at least one of the suggested alternative parameter.

25. The computer readable medium of claim 17, wherein the adjudication includes consideration of patient eligibility, drug interaction, formulary compliance or patient healthcare history.

26. A method of verifying a user in a prescription-related transaction, the method comprising:
receiving a prescription proposal from a portable healthcare device for real-time adjudication;
determining an appropriate benefits manager to adjudicate the prescription proposal; and
if an appropriate benefits manager is identified:
transmitting the prescription proposal to a benefits manager for immediate adjudication of the prescription proposal;
preparing results of the adjudication from the benefits manager for reading at the portable healthcare device;
forwarding the prepared results to the portable healthcare device to be considered in generating a prescription; and
receiving the prescription from the portable healthcare device and transferring the prescription across the network pathway in real-time to the remote prescription site.

27. The method of claim 26, wherein the adjudication results includes at least one of the suggested alternative parameter.

28. The method of claim 27, wherein the prescription includes at least one of the suggested alternative parameter.

29. The method of claim 26, wherein the adjudication includes consideration of patient eligibility, drug interaction, formulary compliance or patient healthcare history.
